(19) United States
(12) Patent Application Publication
(10) Pub. No.: US 2008/0128107 A1
(43) Pub. Date: Jun. 5, 2008

(54) Air conditioning system for construction or agricultural machines

(75) Inventors: Kenichi Yoshii, Nagoya-city (JP); Kazuhiro Fukuta, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/526,809

(22) Filed: Sep. 25, 2006

(30) Foreign Application Priority Data
Sep. 29, 2005 (JP) 2005-283588
Feb. 27, 2006 (JP) 2006-049794

(51) Int. Cl. B60H 1/00

(52) U.S. Cl. 165/42

(57) ABSTRACT

An air conditioning system for construction and agricultural machines is disclosed. A third duct portion (37c) for leading the air-conditioning air from an air-conditioning unit (10) is arranged on a rail (9) for fixing an upper windshield (4a) and a lower windshield (4b), and at least a foot air outlet (40) for blowing out the air-conditioning air toward the knees of the occupant is arranged on the third duct portion (37c). Further, the air-conditioning air (warm air) is blown out of the foot air outlet (40) during the heating operation whereby the occupant can feel warmth in the neighborhood of the knees and the thighs. The occupant of the construction and agricultural machines can thus acquire a warm feeling in the neighborhood of the knees and the thighs during a heating operation of the air conditioning.

### BACKGROUND OF THE INVENTION

1. Field of the Invention

This invention relates to an air conditioning system for construction and agricultural machines or, in particular, to an air conditioning system effectively applicable to construction and agricultural machines including a construction machine such as a hydraulic shovel and an agricultural machine such as a tractor.

2. Description of the Related Art

In the conventional air conditioning system used for the cabin (driver's seat) of a construction machine such a hydraulic shovel, as disclosed in Japanese Unexamined Patent Publication No. 2004-338457, air-conditioned air is blown out substantially symmetrically toward the upper half part of the body and the feet of the occupant from air outlets arranged on the pillars on the left and right fronts of the cabin, and the air-conditioning feeling is improved by avoiding a temperature difference between the left and right sides of the body of the occupant.

The windshield and side window glass of the cabin of the construction and agricultural machines cover a wide area from above the head to below the knees of the seated occupant to secure a wide visual field for the occupant. Even in the case where the air conditioning system is operated in heating mode during the cold season, therefore, the heat can be hardly sensed by the body portions out of reach of the warm air due to the loss of heat to the already-cold window glass.

In the air conditioning system disclosed in Japanese Unexamined Patent Publication No. 2004-338457, however, warm air is blown out toward the upper half part of the body and the feet of the occupant from the air outlets on the left and right fronts of the cabin. Therefore, warm air hardly reaches the knees and the thighs, or the neighborhood thereof, distant from the air outlets, and the loss of heat to the glass causes an insufficient feeling of warmth in the neighborhood of the knees and thighs of the occupant.

### SUMMARY OF THE INVENTION

In view of this situation, the object of this invention is to provide an air conditioning system for construction and agricultural machines in which warmth can be felt in the neighborhood of the knees and thighs of the occupant during a heating operation.

In order to achieve the object described above, according to this invention, there is provided an air conditioning system for construction or agricultural machines with the windshield and the side window glass of the cabin covering a range from above the head to below the knees of the seated occupant, comprising a blower for blowing the air into the cabin, a heating heat exchanger for heating the air blown from the blower, a duct arranged downstream of the heating heat exchanger in the air flow and having warm air passing therethrough after passing the heating heat exchanger, and air outlets for blowing the warm air into the cabin, wherein the duct includes an extension for leading the warm air into the neighborhood of the knees of the occupant seated, and wherein the air outlets are arranged on the extension.

In this configuration, the air outlets are arranged on the extension for leading the warm air to the neighborhood of the knees of the occupant seated and, therefore, the warm air reaches the neighborhood of the knees and the thighs of the occupant more easily during the heating operation, resulting in an improved feeling of warmth in the neighborhood of his/her knees and thighs.

The expression “the neighborhood of the knees” according to the invention is defined as a range in which the warm air blown out of the air outlets can reach the neighborhood of the knees and thighs of the occupant, and may be any position including the front, sides, upper part, etc. of the seated occupant.

According to another aspect of the invention, there is provided an air conditioning system for construction or agricultural machines, further comprising a frame member extending horizontally in the cabin substantially at the height of the knees of the seated occupant, wherein the extension may be fixed on the frame member. Also, at least a part of the extension is configured of the frame member.

In this configuration, the extension can be arranged using the frame member extending horizontally in the cabin substantially at the height of the knees of the seated occupant and, therefore, the extension for leading the warm air to the neighborhood of the knees of the seated occupant can be easily configured.

In the case where the windshield is divided into a plurality of glass panes, the frame member according to the invention should be understood to include a part corresponding to a fixing member (rail) to fix the proximate end sides of the glass panes. In the case where the windshield is configured of a single glass pane, on the other hand, the frame member should be understood to include a part corresponding to a skeleton member for reinforcing the cabin by bridging the left and right pillars.

Also, according to this invention, the word “fix”, “fixed” or “fixing” should be understood to mean not only that the extension fabricated separately from the frame member is fixed immovably on the frame member by fixing means such as screws or clips but also that the frame member and the extension are integrally coupled to each other through a joint so that the extension is immovable with respect to the frame member.

According to still another aspect of the invention, there is provided an air conditioning system for construction or agricultural machines having a frame member, wherein a plurality of air outlets are arranged at predetermined intervals and horizontally on the extension.

In this configuration, the warm air can be blown out over a wide range from the air outlets and, therefore, the loss of heat to the windshield and the side window glass can be further reduced.

According to yet another aspect of the invention, there is provided a air conditioning system for construction or agricultural machines having a console box on at least one side of the seat, wherein the extension may specifically be fixed on the console box. Also, at least a part of the extension may be configured of the console box.

In this configuration, the extension can be arranged using the console box on the side of the seat, and therefore the extension for leading the warm air to the neighborhood of the knees of the seated occupant can be easily configured.

Further, the extension may alternatively be arranged in the console box. In this configuration, the extension for leading the warm air to the neighborhood of the knees of the occupant can be configured without reducing the internal space of the cabin.

According to a further aspect of the invention, there is provided an air conditioning system for construction or agricultural machines having at least a console box, wherein a plurality of air outlets may be vertically arranged, on the extension, at predetermined intervals.

In this configuration, the warm air can be blown out over a wide range through the plurality of the air outlets. As a result, the warm feeling in the neighborhood of the knees of the occupant can be further improved. Also, in view of the fact that the warm air can be blown out over a wide vertical range, the warm feeling in the neighborhood of the knees and thighs of the occupant can be improved regardless of individual differences in the heights of the knees or thighs among the occupants.

According to a still further aspect of the invention, there is provided an air conditioning system for construction or agricultural machines having an entrance door for the occupant, wherein the extension may specifically be fixed on the door. Also, at least a part of the extension may be configured of the door.

In an ordinary construction or agricultural machine, the door used by the occupant to get in and out is arranged on one of the left and right sides of the cabin. According to the invention, the extension can be arranged using the door and therefore can be easily configured to lead the warm air from the side of the seated occupant to the neighborhood of his/her knees.

Further, the extension may be arranged in the door. As a result, the extension for leading the warm air to the neighborhood of the knees of the occupant can be configured without reducing the internal space of the cabin.

The term “the interior of the door” includes the space between the outer panel making up the outdoor side of the door and the door trim making up the indoor side of the door. In the case where inner trim is arranged between the outer panel and the door trim, both the space between the outer panel and the inner panel and the space between the inner trim and the door trim are included.

According to a still further aspect of the invention, there is provided an air conditioning system for construction or agricultural machines having a support member for supporting an operation switch, wherein the extension may be specifically fixed on the support member. Also, at least a part of the extension may be configured of the support member.

The operation switch according to the invention corresponds to the operation switch for the air conditioning system and includes any operation switch for a device mounted on the construction or agricultural machine.

Generally, the operation switch is required to be arranged within the reach of the seated occupant. In the construction or agricultural machine with the windshield and the side window glass of the cabin covering the range from above the head to below the knees of the seated occupant, therefore, the operation switch is arranged in front or on the side of the occupant at about the height of the seat not to hamper the visual field of the occupant.

For this reason, the support member for arranging and supporting the operation switch at appropriate position can be configured to pass through the neighborhood of the knees of the occupant. According to this invention, therefore, the extension can be arranged using the support member. Thus, the extension for leading the warm air to the neighborhood of the knees of the seated occupant can be easily configured.

In the construction or agricultural machines having the features mentioned above, the air outlets may be formed at positions wherefrom the warm air is blown out toward the knees of the seated occupant. By doing so, the warm air is blown out toward the knees of the occupant and, therefore, the warm feeling at the neighborhood of the knees and thighs of the occupant is further improved.

Also, the air outlets may be arranged at positions from which the warm air is blown out toward the windshield. Thus, the windshield can be prevented from being frosted while at the same time reducing the loss of heat to the windshield for an improved warm feeling on the part of the occupant.

As another alternative, the air outlets may be arranged at positions wherefrom the warm air is blown out toward the side window glass. By doing so, the frosting of the side window glass can be prevented while at the same time reducing the loss of heat to the side window glass resulting in an improved warm feeling on the part of the occupant.

The reference numerals in the parentheses attached to the respective means described in the foregoing description and the appended claims designate the correspondence with the specific means described in the embodiments explained below.

The present invention may be more fully understood from the description of preferred embodiments of the invention, as set forth below, together with the accompanying drawings.

### BRIEF DESCRIPTION OF THE DRAWINGS

FIG. 1A is a front view showing a general configuration of a cabin of a hydraulic shovel according to a first embodiment of the invention, and FIG. 1B is a sectional view taken in line A-A in FIG. 1A.

FIG. 2A is a front view showing a general configuration of an air-conditioning unit according to the first embodiment of the invention, FIG. 2B is a sectional view taken in line B-B in FIG. 2A, and FIG. 2C a sectional view taken in line C-C in FIG. 2A.

FIG. 3 is a perspective view of a third foot air duct according to the first embodiment.

FIG. 4 is a perspective view of a third foot air duct according to a second embodiment.

FIG. 5A is a front view showing a general configuration of a cabin of a hydraulic shovel according to a third embodiment of the invention, and FIG. 5B is a sectional view taken in line N-N in FIG. 5A.

FIG. 6A is a front view showing a general configuration of a cabin of a hydraulic shovel according to a fourth embodiment of the invention, and FIG. 6B is a sectional view taken in line P-P in FIG. 6A.

FIG. 7A is a front view showing a general configuration of a cabin of a hydraulic shovel according to a fifth embodiment of the invention, and FIG. 7B is a sectional view taken in line R-R in FIG. 7A.

### DESCRIPTION OF THE PREFERRED EMBODIMENTS

### First Embodiment

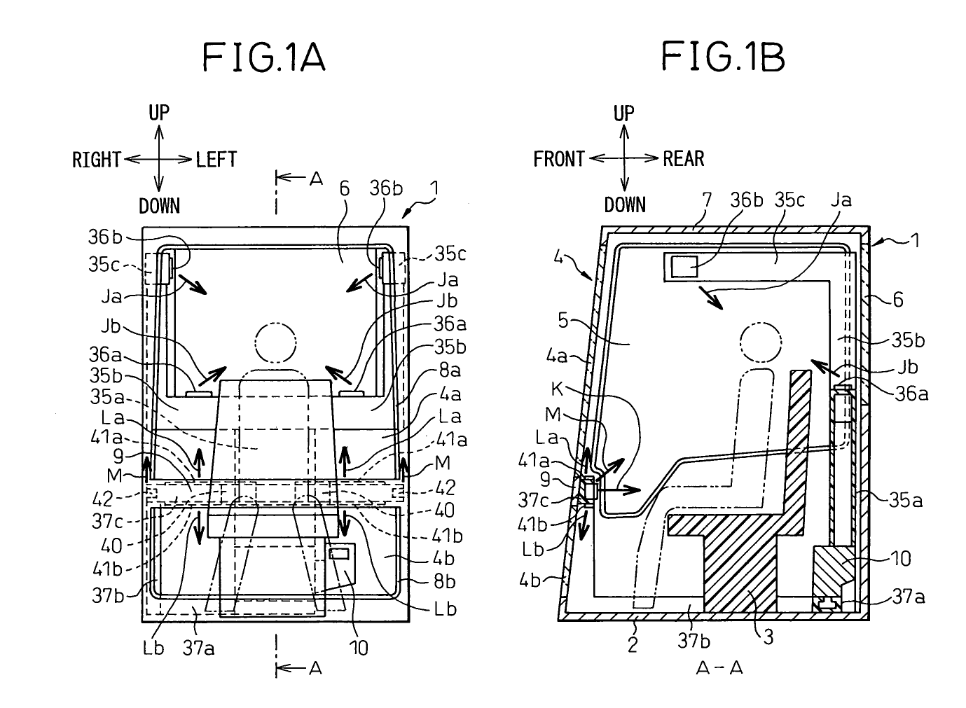

FIGS. 1A and 1B are diagrams showing a general configuration of an air conditioning system for a hydraulic shovel, as a construction or agricultural machine, according to a first embodiment of the invention. FIG. 1A is a front view schematically showing a cabin 1 of the hydraulic shovel according to this embodiment, and FIG. 1B a sectional view taken in line A-A in FIG. 1A.

In FIGS. 1A and 1B, two-dot chain lines schematically show an occupant taking the seat 3 arranged at substantially the central portion on the floor 2 of the cabin 1. The arrows “front/rear”, “up/down” and “left/right” designate the directions “front/rear”, “up/down” and “left/right”, respectively, as viewed from the seated occupant in the cabin 1. The description that follows is based on these directions as viewed from the occupant.

The cabin 1 of the hydraulic shovel includes a windshield 4 on the front side, side window glass 5 on the left and right sides, rear window glass 6 on the rear side, a ceiling 7 and a floor 2, all of which define the internal cabin space. According to this embodiment, a door (not shown in FIGS. 1A, 1B) for the occupant entering/leaving the cabin 1 is arranged on the left side having the side window glass 5 as viewed from the occupant.

The windshield 4 is divided into an upper windshield 4a and a lower windshield 4b fixed on the window frames 8a, 8b, respectively, at the front of the cabin 1. The lower end side of the upper windshield 4a and the upper end side of the lower windshield 4b are fixed by a rail 9.

The rail 9 is an elongate tabular member extended horizontally along the windshields 4a, 4b and substantially at the height of the knees of the seated occupant. The rail 9 thus forms a frame member according to this embodiment.

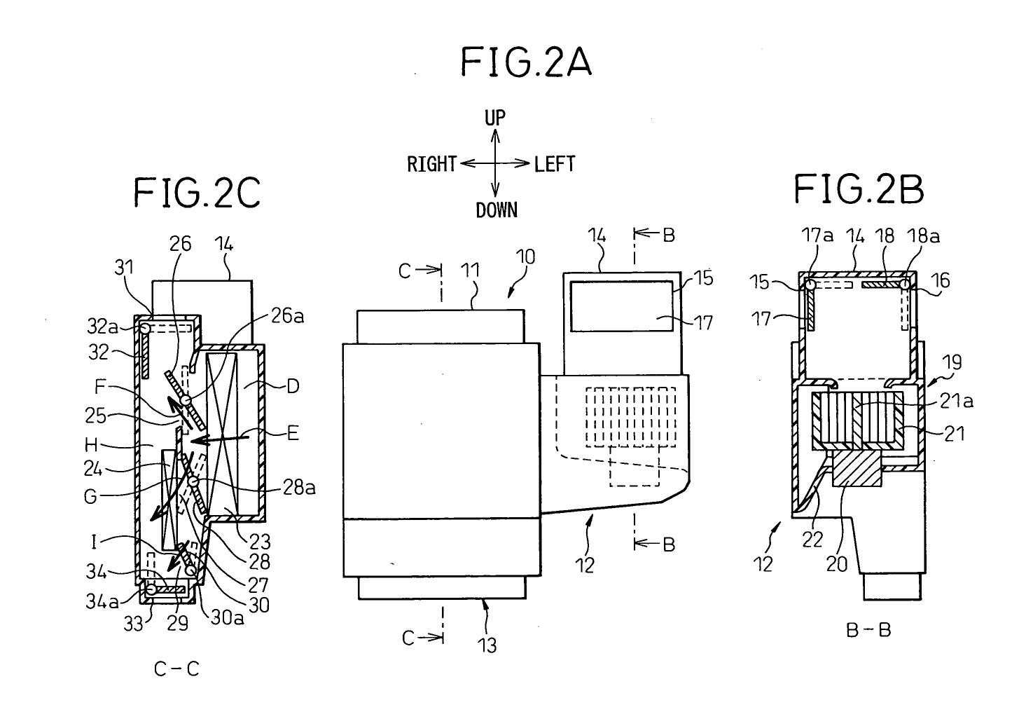

An air-conditioning unit 10 is mounted at a lower position behind the seat 3, i.e. on the floor 2 behind the seat 3. The air-conditioning unit 10, as shown in FIG. 2, constitutes a longitudinally-thin box-like member. FIG. 2A is a front view showing a general configuration of the air-conditioning unit 10, FIG. 2B a sectional view taken in line B-B in FIG. 2A, and FIG. 2C a sectional view taken in line C-C in FIG. 2A.

The air-conditioning unit 10 includes a thin box-like case 11 as described above, in which a blower unit 12 and a heat exchanger unit 13 are arranged and an air path is formed for supplying air into the cabin 1.

The blower unit 12 is arranged on the left side in the case 11, and an internal/external air switch box 14 constituting the most upstream portion of the air path is arranged on the upper left side of the case 11. An internal air leading port 15 for leading the internal air into the case 11 is arranged on the front surface of the internal/external air switching box 14. An external air leading port 16 for introducing the external air into the case 11 is arranged on the rear surface of the internal/external air switch box 14.

As a result, the internal air is introduced from the left lower side of the seat 3, while the external air is introduced from the rear outside of the cabin 1 through a duct (not shown) connecting the external air leading port 16 and the exterior of the cabin 1.

Also, an external air door 18 adapted to open and close the internal air door 17 and the external air leading port 16 for opening and closing the internal air leading port 15 is arranged in the internal/external air switch box 14. The internal air door 17 is driven by an electric actuator (not shown) around the rotary shaft 17a extending horizontally, and the external air door 18 is driven by an electric actuator (not shown) around the rotary shaft 18a extending horizontally.

In the external air mode for introducing the external air, therefore, the internal air door 17 assumes a position for closing the internal air leading port 15 (indicated by solid line), while the external air door 18 takes a position to fully open the external air leading port 16 (indicated by solid line). In the internal air mode for introducing the internal air, on the other hand, the internal air door 17 assumes the position to fully open the internal air leading port 15 (dashed line) while the external air door 18 assumes the position to close the external air leading port 16 (dashed line).

Also, in the external/internal air mode for introducing the external and internal airs at the same time, the external air door 18 and the internal air door 17 are totally fully opened so that the external and the internal air is introduced into the internal/external air switch box 14 from the external air leading port 16 and the internal air leading port 15 at the same time.

An electric blower 19 for blowing air into the cabin is arranged under the internal/external air switch box 14. The blower 19 includes a centrifugal fan 21 rotationally driven by the motor 20 and a scroll casing 22 for accommodating the fan 21.

The fan 21 is a centrifugal fan having a plurality of blades arranged in annular form each having an arcuate cross section. The rotary shaft 21a of the fan 21 is set in vertical direction so that the air is sucked in by the fan 21 from the internal/external air switch box 14 located above.

The scroll casing 22 is arranged to spread downward in such a manner that the air blown by the fan 21 is led to the space (portion D in FIG. 2C) in front of the cooling heat exchanger 23 of the heat exchanger unit 13. The air blown by the fan 21, therefore, flows from the blower unit 12 toward the heat exchanger unit 13 (from left to right).

Next, the heat exchanger unit 13 is explained. The heat exchanger unit 13 is formed on the right side of the blower unit 12 in the case 11. The cooling heat exchanger 23 is arranged on the front side in the heat exchanger unit 13, i.e. upstream of the heat exchanger unit 13 in the air flow.

The cooling heat exchanger 23 is an evaporator of the refrigeration cycle and, as is well known, includes a heat exchange core portion having tubes with the refrigerant passing therethrough and fins coupled to the outer surface of the tubes. The air blown from the blower unit 12 passes rearward through the gap of the heat exchange core portion (in the direction of arrow E in FIG. 2C). The low-temperature low-pressure refrigerant of the refrigeration cycle, after absorbing heat from this passing air, is evaporated thereby to cool the air blown from the blower unit 12.

The compressor (not shown) for circulating the refrigerant of the refrigeration cycle is driven by the engine of the hydraulic shovel through an electromagnetic clutch. The cooling heat exchanger 23 is substantially rectangular and in the same shape as substantially the whole area on the internal front surface of the heat exchanger 13 so that all the air flowing into the front space (D portion) of the cooling heat exchanger 23 can pass through the cooling heat exchanger 23.

Next, in the case 11, a substantially rectangular heating heat exchanger 24 is arranged over substantially the whole width of the heat exchanger unit 13 of the case 11 on the rear lower side of the cooling heat exchanger 23, i.e. on the lower side downstream in the air flow. In other words, the cooling heat exchanger 23 and the heating heat exchanger 24 are arranged serially in the air flow.

The heating heat exchanger 24 is a hot-water heat exchanger for heating the air with the engine cooling water for cooling the engine (not shown) of the hydraulic shovel as a heat source and, as is well known, includes tubes with warm water passing therethrough and a heat exchange core portion coupled to the outer surface of the tubes. The air downstream of the cooling heat exchanger 23 is heated as it passes through the gap of the heat exchange core portion.

A first bypass 25 is formed above the heating heat exchanger 24. This first bypass 25 is a path through which the air cooled through the cooling heat exchanger 23 during the cooling operation is passed rearward of the heating heat exchanger 24 without being heated by the heating heat exchanger 24. Thus, the air passed through the first bypass 25 flows in the direction of arrow F in FIG. 2C.

This first bypass 25 is adapted to be opened/closed by the first bypass door 26, which is a tabular door rotatable around the rotary shaft 26a extending horizontally and driven by an electric actuator (not shown).

Also, a warm air path 27 is formed between the heating heat exchanger 24 and the cooling heat exchanger 23. This warm air path 27 is for leading the air cooled in the cooling heat exchanger 23 during the heating operation to the heating heat exchanger 24 where it is heated. Thus, the air passed through the warm air path 27 flows in the direction of arrow G in FIG. 2C.

This warm air path 27 is adapted to be opened and closed by a warm air door 28. The warm air door 28 is a tabular door rotatable around the rotary shaft 28a extending horizontally. According to this embodiment, the warm air door 28 is driven in operatively interlocked relation with the first bypass door 26 by the electric actuator shared with the first bypass door 26 through a mechanical link mechanism (not shown).

In the peak cooling operation, the first bypass door 26 is located at the position (solid line) to open the first bypass 25 full while the warm air door 28 is located at the position (solid line) to close the warm air path 27. As a result, all the air cooled while passing through the cooling heat exchanger 23 bypasses the heating heat exchanger 24.

In the peak heating operation, on the other hand, the first bypass door 26 is located at the position (dashed line) to close up the first bypass 25 while the warm air door 28 is located at the position (dashed line) to fully open the warm air path 27. As a result, all the air cooled while passing through the cooling heat exchanger 23 is heated by passing through the heating heat exchanger 24.

Further, when the first bypass door 26 and the warm air door 28 are located at the intermediate position, the cool air flowing in the first bypass 25 mixes with the warm air flowing through the warm air path 27 and heated by the heating heat exchanger 24 in the space (portion H in FIG. 2C) formed in the rearmost part in the case 11. By adjusting the opening degree of the first bypass door 26 and the war air door 28, therefore, the mixing ratio between the cool and warm air can be adjusted thereby to produce air-conditioning air at the desired temperature.

A second bypass 29 is formed under the heating heat exchanger 24. Through this second bypass 29, the air cooled through the cooling heat exchanger 23 during the cooling operation is passed rearward of the heating heat exchanger 24 without being heated by the heating heat exchanger 24. Thus, the air passing through the second bypass 29 flows in the direction of arrow I in FIG. 2C.

This second bypass 29 is adapted be opened and closed by the second bypass door 30, which is a tabular door rotatable around the rotary shaft 30a extending horizontally and driven by an electric actuator (not shown).

The second bypass door 30 is operated to be located the closed-up position (indicated by solid line) of the second bypass 29 when the foot air door 34 described later is in such a position as to close the foot air duct joint port 33.

Further, the second bypass door 30 is so operated that when the foot air door 34 is in such a position as to fully open the foot air duct joint port 33 during the peak cooling operation, the second bypass 29 is fully opened (dashed line), while when the foot air door 34 is in such a position as to fully open the foot air duct joint port 33 during the peak heating operation, on the other hand, the second bypass 29 is closed up (solid line).

Also, a face air duct joint port 31 is arranged on the rear upper surface of the heat exchange unit 13 of the case 11, i.e. on the upper surface of the heat exchanger unit 13 downstream of the heating heat exchanger 24, the first bypass 25 and the second bypass 29 in the air flow.

This face air duct joint port 31 is adapted to be opened and closed by the face door 32 to be connected to one face air duct 35 described later. The face air duct 32 is a tabular door rotatable around the rotary shaft 32a extending in horizontal direction and driven by an electric actuator (not shown).

In the case where the air-conditioning air is blown out from the face air outlets 36a, 36b described later, the face air duct joint port 31 is fully opened (solid line), while in the case where no air-conditioning air is blown out from the face air outlets 36a, 36b, on the other hand, the face air duct joint port 31 is closed (dashed line).

Also, a foot air duct joint port 33 is arranged on the rear lower surface of the heat exchanger unit 13 of the case 11, i.e. on the lower surface of the heat exchanger unit 13 vertically distant from the face air duct joint port 31 downstream of the heating heat exchanger 24, the first bypass 25 and the second bypass 29.

This foot air duct joint port 33 is connected to the foot air duct 37 described later and adapted to be opened/closed by the foot air door 34. The foot air door 34 is a tabular door rotatable around the rotary shaft 3a extending in horizontal direction and driven by an electric actuator (not shown).

The foot air door 34 is so operated that when the air-conditioning air is blown from the foot air outlet 40, the defroster air outlets 41a, 41b and the side defroster air outlet 42, the foot air duct joint port 33 is fully opened (dashed line), while when no air-conditioning air is blown out from the foot air outlet 40, the defroster air outlets 41a, 41b and the side defroster air outlet 42, on the other hand, the foot air duct joint port 33 is closed (solid line).

The face air duct joint port 31 of the air-conditioning unit 10 is connected with a face air duct 35. This face air duct 35 leads the air-conditioning air flowing out of the air-conditioning unit 10 to the face air outlets 36a, 36b described later.

The face air duct 35 includes a first duct portion 35a for leading the air-conditioning air from the face air duct joint port 31 to the upper side of the seatback of the seat 3, a second duct portion 35b for splitting the air-conditioning air flow in right and left directions at the upper end of the first duct portion 35a and leading the air-conditioning air to the ceiling 7a along the rear left and right wall surfaces in the cabin 1, and a third duct portion 35c extending forward along the ceiling from the ceiling side ends of the left and right second duct portions 35b.

According to this embodiment, the first to third duct portions 35a, 35b, 35c are formed of resin in a plurality of divisions for the convenience of molding. This plurality of the division ducts are coupled integrally with each other by fastening means such as screws and clips to thereby make the face air duct 35.

The first face air outlets 36a are arranged at two points on the second duct portion 35b to blow out the air-conditioning air flowing out of the air-conditioning unit 10 from the left and right sides of the seatback 3a of the seat 3 toward the face of the occupant. Also, the second face air outlets 36b are arranged at each end of the third duct portion 35c to blow out the air-conditioning air from the neighborhood of the front end of the third duct portion 35c toward the face of the occupant.

The first and second face air outlets 36a, 36b each have a movable blowout grille (not shown), whereby the first and second face air outlets 36a, 36b can be closed.

The foot air duct joint port 33 of the air-conditioning unit 10 is connected with the foot air duct 37. The air-conditioning air flowing out of the air-conditioning unit 10 is led by the foot air duct 37 to the foot air outlet 40, the defroster air outlets 41a, 41b and the side defroster air outlet 42 described later.

Also, the foot and duct 37 includes a first duct portion 37a for leading the air-conditioning air from the foot air duct joint port 33 to the inner wall surface of the cabin 1 on the right side as viewed by the occupant, a second duct portion 37b for leading the air-conditioning air from the side end of the right inner wall surface of the first duct portion 37a to the lower windshield 4b along the right wall surface and further from the lower windshield 4b to the upper rail 9, and a third duct portion 37c extended along the rail 9 from the rail 9 side end of the second duct portion 37b.

Further, the third duct portion 37c is fixed on the rail 9. According to this embodiment, therefore, the third duct portion 37c constitutes the extension for leading the warm air to the neighborhood of the knees of the seated occupant. The reason whey the second duct portion 37b leads the air-conditioning air along the right wall surface of the cabin 1 is to allow the occupant to get on and off the vehicle in view of the fact that as described above, the door for the occupant is arranged on the left side of the cabin.

Further, according to this embodiment, the first to third foot air ducts 37a, 37b, 37c are made of resin and for the convenience of molding, split into a plurality of divisions. The foot air duct 37 is configured by integrally coupling the plurality of the division ducts with fastening means such as screws or clips.

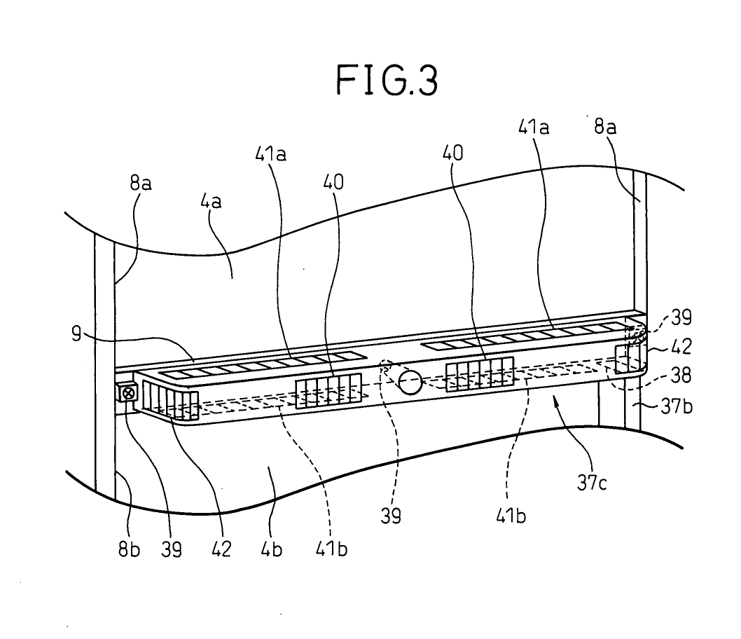

The third duct portion 37c is explained in detail with reference to FIG. 3. FIG. 3 is a perspective view of the third foot air duct 37 mounted on the rail 9 as taken from upper left internal part of the cabin 1. The third duct portion 37c includes a second foot air duct joint 38, which is coupled to the rail 9 side end of the second duct portion 37b as described above.

Further, the third duct portion 37c according to this embodiment has through holes 39 by way of which it is screwed to the rail 9. The through holes 39 are formed at three points, i.e. the ends and central portion of the third duct portion 37c. Also, the rail 9 has threaded holes (not shown) at three points corresponding to the through holes 39. The third duct portion 37c is fixed on the rail 9 by the screws inserted in the through holes 39.

Also, the third duct portion 37c has foot air outlets 40 for blowing out the air-conditioning air from the air-conditioning unit 10 toward the knees of the occupant. The foot air outlets 40 are arranged at two points near the left and right knees of the seated occupant on the occupant side surface (the surface directed rearward of the cabin) of the third duct portion 37c fixed on the rail 9.

Further, defroster air outlets 41a for blowing out the air-conditioning air toward the upper windshield 4a are arranged on the upper surface of the third duct portion 37c fixed on the rail 9. The defroster air outlets 41a are arranged at two left and right points and are directed substantially from the center to the left and right ends of the third duct portion 37c.

Also, defroster air outlets 41b for blowing out the air-conditioning air toward the lower windshield 4b are arranged on the lower surface of the third duct portion 37c. The defroster air outlets 41b are arranged at two left and right points directed substantially from the center to the left and right ends of the third duct portion 37c. Further, side window defroster air outlets 42 for blowing out the air-conditioning air toward the left and right side window glass 5 are arranged at two left and right points at the ends of the third duct portion 37c.

The foot air outlets 40, the defroster air outlets 41a, 41b and the side window defroster air outlets 42 each have a movable blowout grille, whereby the foot air outlets 40, the defroster air outlets 41a, 41b and the side window defroster air outlets 42 can be closed.

An instrument board (not shown) is arranged at the lower central portion on the inner front part of the cabin 1. The air-conditioning operation panel of the instrument board includes a compressor operation switch for the refrigeration cycle, an automatic control mode (auto mode) setting switch, a temperature setting switch, an air capacity switch for manual operation, a blowout mode change-over switch and an internal/external air mode change-over switch.

The air-conditioning operation panel according to this embodiment, though arranged at the lower central portion on the front of the cabin 1, may alternatively be arranged on the front right side of the cabin 1 or in the spaced on the right front side of the cabin 1 depending on the position of the operation levers of the hydraulic shovel. In the case where the steering means is arranged on the front of the cabin 1 as in the agricultural machine, on the other hand, the air-conditioning operation panel may be arranged on the ceiling 7.

Next, the operation of this embodiment is explained. The compressor starting switch on the air-conditioning operation panel is turned on. Then, the electromagnetic clutch of the compressor of the refrigeration cycle is activated and connected. Thus, the compressor is driven by the engine. As a result, the low-temperature low-pressure refrigerant of the refrigeration cycle in the cooling heat exchanger 23 is evaporated by absorbing heat from the air thereby to cool the air.

Once the auto switch is turned on, the operation of adjusting the temperature of the air-conditioning air and switching the blowout mode are automatically performed in accordance with the temperature set by the temperature setting switch. The operation of adjusting the temperature of the air-conditioning air and switching the blowout mode can be also manually performed.

In the operation of adjusting the temperature of the air-conditioning air, as described above, both the first bypass door 26 and the warm air door 28 are manipulated, so that the mixing ratio between the cool air flowing in the defroster air outlet 25 and the warm air flowing through the warm air path 27 and heated by the heating heat exchanger 24 is adjusted.

The blowout mode includes the face mode selected mainly for a cooling operation during the summer season, the foot defroster mode selected mainly for a heating operation during the winter season and the bilevel mode selected mainly in the spring and autumn.

In the face mode normally used for the cooling operation during the summer season, the face door 32 is set to the position (solid line) to fully open the face air duct joint port 31, the foot door 34 is set to the position (solid line) to close the foot air duct joint port 33, and the second bypass door 30 is set to the position (solid line) to close the second bypass 29.

The air-conditioning air (cool air) is blown out in the direction of arrow Jb toward the face of the occupant from the first face air outlets 36a through the face air duct joint port 31 and the fact air duct 35.

In the foot defrost mode normally used for the heating operation during the winter season, on the other hand, the face door 32 is set to the position (dashed line) to close up the face air duct joint port 31, the foot door 34 is set to the position (dashed line) to open full the foot air duct joint port 33, and the second bypass door 30 is set to the position (solid line) to close up the second bypass 29.

As a result, the air-conditioning air (warm air) is blown out from the foot air outlets 40, the defroster air outlets 41a, 41b and the side window defroster air outlets 42 through the foot air duct joint port 33 and the foot air duct 37.

The interior of the cabin 1 is heated by blowing out the warm air from the foot air outlets 40 toward the knees of the occupant in the direction shown by arrow K. Also, the warm air is blown out toward the upper windshield 4a in the direction indicated by arrow La from the defroster air outlet 41a, and the warm air is blown out from the defroster air outlet 41b toward the lower windshield 4b as indicated by arrow Lb, thereby exhibiting the function to defrost the upper and lower windshields 4a, 4b.

Further, the side window glass 5 is prevented from being frosted by blowing out the warm air from the side window defroster air outlets 42 toward the side window glass 5 in the direction indicated by arrow M.

In the case where the glass is required to be defrosted quickly, the foot air outlets 40 are closed by the blowout grilles of the foot air outlets 40 and the warm air blowout from the foot air outlets 40 is cut off. As a result, the capacity of the air blown out from the defroster air outlets 41a, 41b and the side window defroster air outlets 42 can be increased to enhance the glass defrosting function.

In the bilevel mode used in the spring and autumn, the temperature of the air blown out to the face from the first and second face air outlets 36a, 36b is set lower by a predetermined amount than the temperature of the foot air blown out from the foot air outlets 40. In this way, the vertical blowout air temperature difference is set to keep the head-cold and the feet-warm pattern to improve the comfort of the occupant.

Specifically, the face air door 32 is set in the position (solid line) to full open the face air duct joint port 31, the foot air door 34 in the position (dashed line) to full open the foot air duct joint port 33, and the second bypass door 30 in the position (dashed line) to full open the second bypass 29.

As a result, the air-conditioning air constituting a mixture of the cool air indicated by arrow F passed through the first bypass 25 and the warm air indicated by arrow G passed through the warm air path 27 is blown out from the first and second face air outlets 36a, 36b. Also, the air-conditioning air constituting a mixture of the warm air indicated by arrow G passed through the warm air path 27 and the cool air indicated by arrow I passed through the second bypass 29 is blown out from the foot air outlets 40, the defroster air outlets 41a, 41b and the side window defroster air outlets 42.

In the process, the capacity of the cool air indicated by arrow F passed through the first bypass 25 is larger than that of the cool air indicated by arrow I passed through the second bypass 29, and therefore the temperature of the air blown out to the face can be set lower than the temperature of the air blown out to the feet by a predetermined amount.

In this embodiment, the air conditioning system operates as described above. During the heating operation, the air-conditioning air (warm air) can be blown out toward the knees of the occupant from the foot air outlets 40 arranged in the third duct portion 37c, and therefore a warm feeling in the neighborhood of the knees and thighs, of the occupant, is improved.

Further, during the heating operation, the air-conditioning air (warm air) can be blown out from the defroster air outlets 41a, 41b arranged on the third duct portion 37c toward the windshield 4. The function of preventing the frosting of the windshield 4 can thus be exhibited, while at the same time alleviating a coldness of the skin which the occupant otherwise might feel due to a loss of heat to the windshield 4.

Furthermore, during the heating operation, the air-conditioning air (warm air) can be blown out from the side window defroster air outlets 42 arranged on the third duct portion 37c toward the side window glass 5. The function of preventing the frosting of the side window glass 5 can thus be exhibited while at the same time reducing the cold feeling of the skin which otherwise might be caused on the part of the occupant by the loss of heat to the side window glass 5.

### Second Embodiment

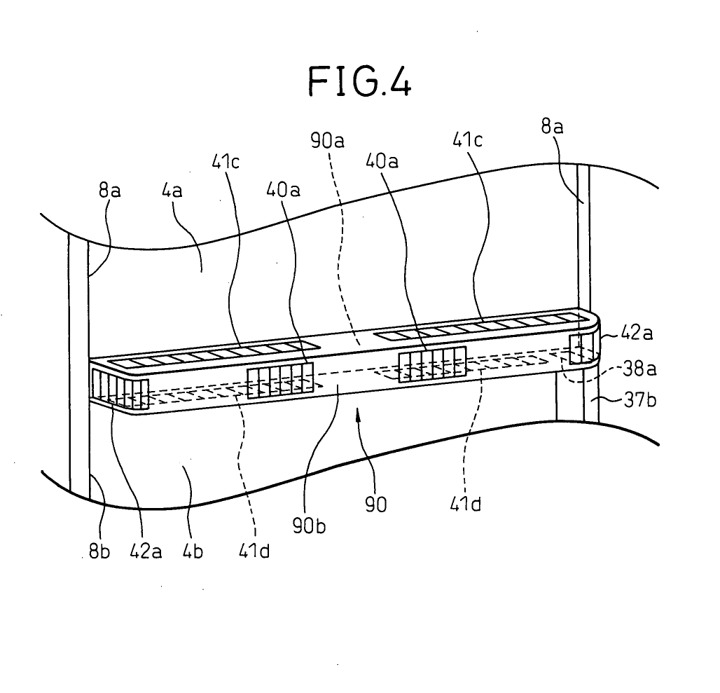

According to the first embodiment described above, the rail 9 and the third duct portion 37c are formed as separate members and fixed to each other with screws. According to the second embodiment, on the other hand, the rail 9 and the third duct portion 37c are eliminated, and a rail 90 shown in FIG. 4 is used in place. The other parts of the configuration are similar to those of the first embodiment.

FIG. 4 is a perspective view of the rail 90 as taken from the upper left point in the cabin 1. The rail 90 is a substantially parallelopipedal member having an internal hollow space. The lower end side of the upper windshield 4a and the upper end side of the lower windshield 4b are fixed on the font surface 90a of the rail 90. Thus, the rail 90 makes up a frame member according to this embodiment.

Further, a second foot air duct joint 38a is arranged on the lower right end surface of the rail 90 and is connected with the rail 90 side end of the second duct portion 37b. As a result, the air-conditioning air introduced through the second duct portion 37b can be passed through the internal space of the rail 90.

Also, the rail 90 has foot air outlets 40a for blowing out the air-conditioning air from the air-conditioning unit 10 toward the knees of the occupant. The foot air outlets 40a are arranged at two points near the left and right knees of the seated occupant on the occupant side (rear surface) of the rail 9.

Further, defroster air outlets 41c for blowing out the air-conditioning air toward the upper windshield 4a are arranged on the upper surface of the rail 90. The defroster air outlets 41c are arranged at two left and right points directed toward the left and right ends substantially from the center of the upper surface of the rail 90.

Also, defroster air outlets 41d for blowing out time air-conditioning air toward the lower windshield 4b are arranged on the lower surface of the rail 90. The defroster air outlets 41d are arranged at two left and right points directed toward the left and right ends substantially from the center of the lower surface of the rail 90.

Further, the side window defroster air outlets 42a for blowing out the air-conditioning air toward the left and right side window glass 5 are arranged at two left and right points at the ends of the rail 90. The foot air outlets 40a, the defroster air outlets 41c, 41d and the side window defroster air outlet 42a are each formed with a movable blowout grille (not shown) as in the first embodiment.

According to this embodiment, therefore, the outer wall surface of the rail 90 makes up the third duct portion 90b, which constitutes an extension for leading the warm air to the neighborhood of the knees of the seated occupant. Specifically, at least a part of the third duct portion 90b (extension) is configured of the rail 90 (frame member).

The air conditioning system, if operated with the configuration described above, can produce quite the same effects as in the first embodiment. Further, in view of the fact that the third duct portion 90b corresponding to the extension is formed integrally with the rail 90, the job of coupling the third duct portion 90b to the rail 90 by screws, etc. is eliminated.

### Third Embodiment

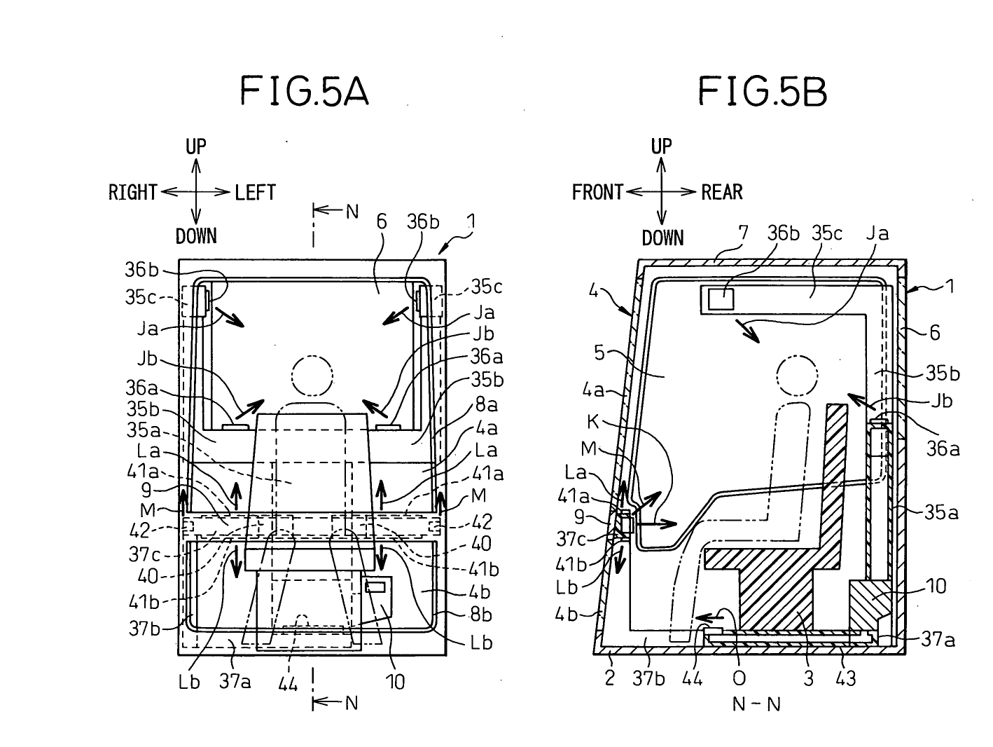

According to the first embodiment described above, the air-conditioning air from the air-conditioning unit 10 is blown out from the first and second face air outlets 36a, 36b through the face air duct 35, and at the same time, blown out from the foot air outlets 40, the defroster air outlets 41a, 41b and the side window defroster air outlets 42 through the foot air duct 37. According to the third embodiment, on the other hand, the system further includes a second foot air duct 43 and a second foot air outlet 44 as shown in FIGS. 5A, 5B. The other parts of the configuration are similar to those of the first embodiment.

FIG. 5A is a front view schematically showing the cabin 1 of the hydraulic shovel according to this embodiment, and FIG. 5B a sectional view taken in line N-N in FIG. 5A. Also, in FIGS. 5A and 5B, the component parts having the functions identical or equivalent to those in the general configuration of the first embodiment (FIG. 1) are designated by the same references, respectively.

The second air foot duct 43 is a pipe for leading the air-conditioning air from the air-conditioning unit 10 to a second foot air outlet 44 described later. The second foot air duct 43 is connected to communicate with the foot air duct 37a and arranged on the upper surface of the floor 2 of the cabin 1 in such a manner as to extend substantially to the neighborhood of the feet of the occupant. The second foot air outlet 44 for blowing out the air-conditioning air toward the feet (specifically, the neighborhood of the ankles) of the occupant is arranged at the end of the second foot air duct 43 near to the feet of the occupant.

The operation of the air conditioning system with the aforementioned configuration can produce quite the same effects as in the first embodiment. Further, the air-conditioning air (warm air) can be blown out in the direction of arrow 0 in FIG. 5B by the provision of the second foot air outlet 44, and therefore a warm feeling can be obtained at the feet as well as at the knees and thighs of the occupant during the heating operation.

### Fourth Embodiment

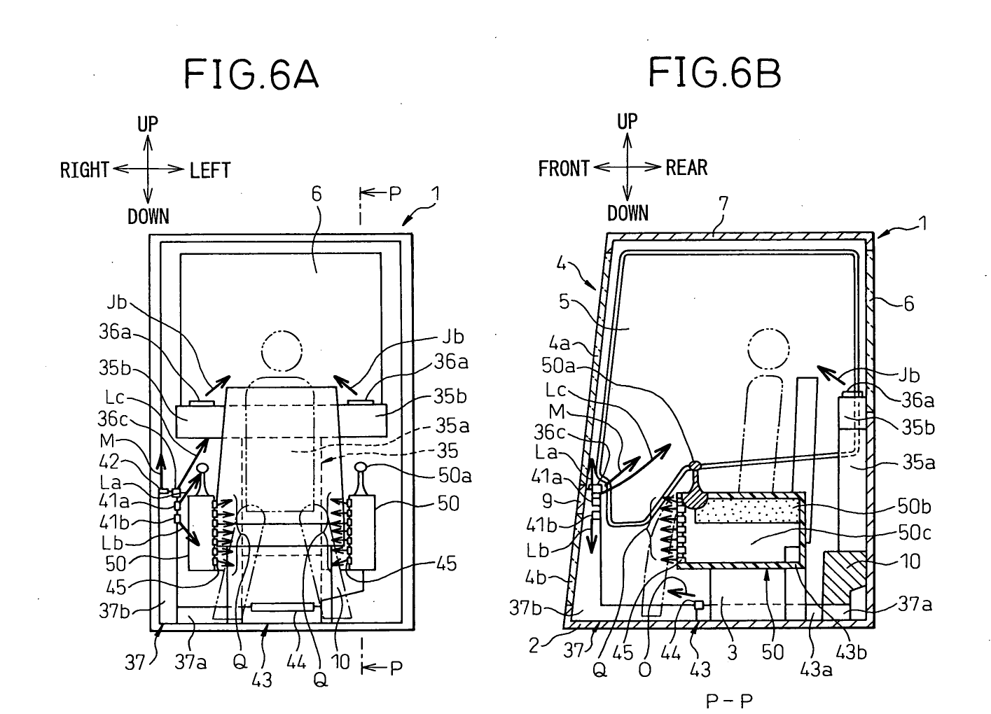

According to the first to third embodiments described above, the third duct portion 37c and the third duct portion 90b (extension) are configured of the rail 9, 90 to lead the warm air to the neighborhood of the knees of the seated occupant. According to the fourth embodiment, on the other hand, as shown in FIGS. 6A, 6B, the warm air is led to the neighborhood of the knees of the occupant using the console boxes 50 arranged on the left and right sides of the seat 3. The details of the console box 50 are explained later.

FIGS. 6A, 6B are diagrams showing a general configuration of this embodiment, in which FIG. 6A is a front view schematically showing the cabin 1 of the hydraulic shovel according to this embodiment, and FIG. 6B a sectional view taken in line P-P in FIG. 6A. For the convenience of illustration, FIG. 6A shows the inside front of the cabin 1 without showing the windshield 4, the window frames 8a, 8b and the rail 9. In FIGS. 6A, 6B, the component parts having the functions identical or equivalent to those of the general configuration of the third embodiment (FIGS. 5A, 5B) are designated by the same reference numerals, respectively.

First, the air-conditioning unit 10 has quite the same configuration as that of the first embodiment, and the face air duct 35 is connected to the face air duct joint port 31 of the air-conditioning unit 10. This face air duct 35 is a pipe for leading the air-conditioning air from the air-conditioning unit 10 to the face air outlets 36a.

The face air duct 35 according to this embodiment includes a first duct portion 35a for leading the air-conditioning air from the face air duct joint port 31 to the upper side of the seatback of the seat 3, and a second duct portion 35b for splitting the air-conditioning air flow into left and right parts at the upper end of the first duct portion 35a and leading the two air flows to the rear left and right wall surfaces in the cabin 1.

The first face air outlets 36a for blowing out the air-conditioning air toward the face of the occupant from the left and right sides of the seatback 3a of the seat 3 are arranged at two points on the second duct portion 35b. The other component parts of the face air duct 35 are similar to those of the face air duct 35 according to the first embodiment.

The foot air duct joint port 33 of the air-conditioning unit 10 is connected with the first foot air duct 37. Further, as in the third embodiment, the second foot air duct 43 is connected to communicate with the first foot air duct 37.

The first foot air duct 37 is a pipe for leading the air-conditioning air from the air-conditioning unit 10 to the defroster air outlets 41a, 41b, the side window defroster air outlet 42 and the second face air outlet 36c, while the second foot air duct 43 is a pipe for leading the air-conditioning air flowing out from the air-conditioning unit 10 to the first and second foot air outlets 45, 44.

The first foot air duct 37 according to this embodiment includes, as in the first embodiment, the first duct portion 37a and the second duct portion 37b. The end of the second duct portion 37b near to the rail 9 is formed with the defroster air outlet 41a for blowing out the air-conditioning air toward the upper windshield 4a, the defroster air outlet 41b for blowing out the air-conditioning air toward the lower windshield 4b and the side window defroster air outlet 42 for blowing out the air-conditioning air toward the right side window glass 5.

Further, according to this embodiment, the second face air outlet 36 for blowing out the air-conditioning air toward the face of the occupant is arranged at the end of the second duct portion 37b near to the rail 9. This second fact air outlet 36c is intended to blow out the air-conditioning air from the first foot air duct 37 toward the face of the occupant, and used by the occupant by opening and closing the movable blowout grilles as desired in the foot defrost mode and the bilevel mode. The other component parts of the configuration of the first foot air duct 37 are similar to those of the foot air duct 37 according to the first embodiment.

The second foot air duct 43, as in the third embodiment, includes a first duct portion 43a arranged on the upper surface of the floor of the cabin 1 in such a manner as to extend to the neighborhood of the feet of the occupant, and a second foot air outlet 44 for blowing out the air toward the feet (specifically, the neighborhood of the ankles) of the occupant is arranged at the end of the first duct portion 43a near to the feet of the occupant.

Further, the second foot air duct 43 according to this embodiment has second duct portions 43b on both left and right sides configured so that the air-conditioning air is passed through the internal hollow space 50c of the left and right console boxes 50. Specifically, the second duct portions 43b are configured to communicate with the first duct portions 43a on the rear left and sides of the first duct portion 43a behind the seat 3.

The console box 50 will be explained in detail. Each console box 50 according to this embodiment is a box-like member of resin, on the upper surface of which the operation lever 5a of the hydraulic shovel is arranged. The interior of the console box 50 is configured of an accommodation space 50b for accommodating the lower part of the operation lever 50a and hydraulic cables, electric cables, etc. for operating the operation lever 50a and the hydraulic shovel in mechanically and electrically interlocked relation with each other.

For the convenience of illustration, FIG. 6B shows the accommodation space 50 in simplified fashion. Nevertheless, the size and shape of the accommodation space 50b are of course varied with the size and shape of the corresponding console box 50 and the state of the hydraulic and electric cables accommodated.

Also, the space not constituting the internal accommodation space 50b of each console box 50 makes up a hollow space 50c, through which the air-conditioning air flows. Further, the side surface of the console box 50 near to the occupant is formed with a first foot air outlet 45 communicating with the hollow space 50c to blow out the air-conditioning air toward the knees of the occupant.

According to this embodiment, therefore, the second duct portion 43b is configured of the outer wall surface of the console box 50 and constitutes an extension for leading the warm air to the neighborhood of the knees of the seated occupant. Specifically, at least a part of the second duct portion 43b (extension) is configured of the console box 50. Also, a plurality of first foot air outlets 45 are arranged vertically at predetermined intervals in front of the occupant side of the console box 50.

Although the console boxes 50 for accommodating the operation lever 50a, etc. are employed according to this embodiment, any console box used as an arm rest or a glove compartment as well as to accommodate the operation lever can of course be employed as the second duct portion 43b (extension) if it is capable of containing the hollow space for passing the air-conditioning air.

The operation of this embodiment having the above-mentioned configuration is explained. The air-conditioning unit 10 operates in the same manner as the first embodiment, and in face mode, the air-conditioning air (cool air) is blown out in the direction of arrow Jb toward the face of the occupant from the first face air outlet 36a through the face air duct joint port 31 and the face air duct 35. The interior of the cabin 1 is cooled by this air-conditioning air blown out in the direction of arrow Jb.

In foot defrost mode, on the other hand, the air-conditioning air (warm air) is blown out from the defroster air outlets 41, 41b, the side window defroster air outlet 42 and the second face air outlet 36c through the foot air duct joint port 33 and the first foot air duct 37. The air-conditioning air is also blown out from the first foot air outlet 45 and the second foot air outlet 44 through the foot air duct joint port 33 and the second foot air duct 43.

The warm air from the defroster air outlet 41a is blown out toward the upper windshield 4a in the direction indicated by arrow La, and exhibits the function of defrosting the upper windshield 4a. Also, the warm air blown out of the defroster air outlet 41b is blown toward the lower windshield 4b as indicated by arrow Lb and exhibits the function of defrosting the lower windshield 4b.

The warm air blown out of the side window defroster air outlet 42 is blown out toward the side window glass 5 in the direction of arrow M and exhibits the function of defrosting the side window glass 5. Further, the air-conditioning air is blown out toward the knees of the occupant in the direction of arrow Q from the first foot air outlets 45, on the one hand, and toward the feet of the occupant in the direction of arrow 0 from the second foot air outlet 44, on the other hand, thereby to heat the interior of the cabin 1.

In bilevel mode, as in the first embodiment, the air blown out to the face from the first face air outlets 36a is set a predetermined amount lower in temperature than the air blown out to the feet from the first and second foot air outlets 45, 44. In this way, a temperature difference is set between the upper and lower air blown out in what is called a head-cold feet-warm fashion to improve the comfort of the occupant.

According to this embodiment, the air-conditioning air is blown out from the second face air outlet 36c through the first foot air duct 37. Therefore, the head-cold feet-warm temperature distribution pattern can be changed as desired by the occupant by opening and closing the second face air outlet 36c. Thus, the air-conditioning feeling can be further improved.

In this way, according to this embodiment, the air-conditioning air (warm air) can be blown out aimed at the knees of the occupant from the first foot air outlets 45 arranged on the console boxes 50 making up the second air duct portion 43b during the heating operation, and therefore, a warm feeling in the neighborhood of the knees and thighs of the occupant can be improved.

Further, in view of the fact that the second duct portion 43b is formed of the hollow space 50c of each console box 50, a duct dedicated to blowing out the air-conditioning air (warm air) toward the knees of the occupant is not required in the cabin 1. As a result, the warm feeling of the knees and thighs of the occupant can be improved without reducing the internal space of the cabin 1.

Furthermore, in view of the fact that a plurality of first foot air outlets are arranged vertically at predetermined intervals on the side of the console box 50 near to the occupant, the warm air can be blown out over a wide range in the neighborhood of the knees and thighs of the occupant, thereby improving the warm feeling in the neighborhood of the knees and thighs even more. Also, the fact that the warm air can be blown out over a wide range improves the warm feeling regardless of individual differences in the heights of knees and thighs.

According to this embodiment, the second duct portion 43b (extension) is configured of the console boxes 50 using the hollow space 50c of the console boxes 50. As an alternative, a duct dedicated to the communication between the first duct portion 43b and the first foot air outlets 45 may be fixedly arranged in the console boxes 50 and employed as an extension to produce similar effects.

### Fifth Embodiment

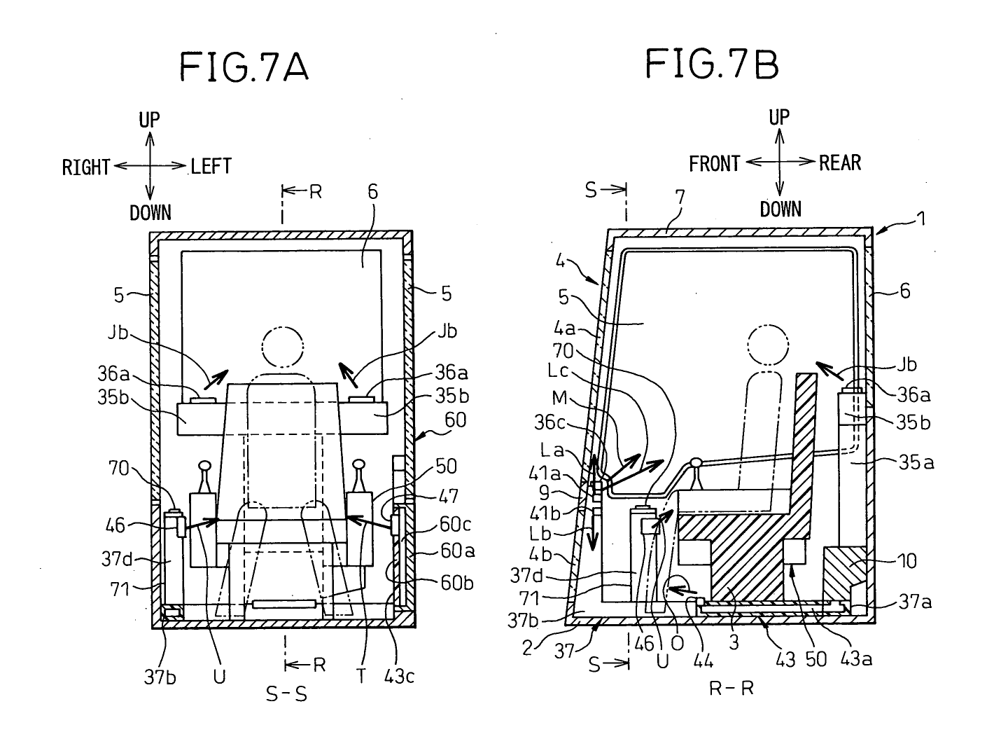

According to the fourth embodiment, the second duct portion 43b (extension) is formed integrally with the console boxes 50 to lead the warm air to the neighborhood of the knees of the occupant. According to the fifth embodiment, on the other hand, as shown in FIGS. 7A, 7B, the warm air is led to the neighborhood of the knees of the occupant using a support member 71 for fixing a door 60 for the occupant and an operation switch 70.

FIGS. 7A, 7B are diagrams showing a general configuration of this embodiment, in which FIG. 7A is a front view schematically showing the cabin 1 of the hydraulic shovel according to this embodiment, and FIG. 7A is a sectional view taken in line R-R in FIG. 7A. In FIG. 7A, the sectional view taken in line S-S in FIG. 7B is shown to illustrate the front view of the interior of the cabin 1 by omitting the windshield 4, the window frames 8a, 8b and the rail 9. Also, the component parts having the functions identical or equivalent to those in the diagrams (FIGS. 6A, 6B) of a general configuration according to the fourth embodiment are designated by the same reference numerals, respectively.

First, the air-conditioning unit 10 and the face air duct 35 are similar to those of the fourth embodiment. The first foot air duct 37, having a basically similar configuration to that of the fourth embodiment, includes the first duct portion 37a and the second duct portion 37b, and the defroster air outlet 41a, the defroster air outlets 41b, the side window defroster air outlets 42 and the second face air outlet 36c are arranged at the end of the second duct portion 37b nearer to the rail 9.

Further, according to this embodiment, a third duct portion 37d extends in vertical direction at a position diagonally forward of the first duct potion 37a in front of the seated occupant. The third duct portion 37d extends substantially up to the height of the knees of the seated occupant upward from the upper surface of the first duct portion 37a. An operation switch 70 is arranged on the uppermost surface of the third duct portion 37d, and a switch-side foot air outlet 46 for blowing out the air-conditioning air toward the knees of the occupant is arranged in the neighborhood of the knees on the side of the occupant.

The operation switch 70 according to this embodiment is specifically an air conditioning system operation switch described in the first embodiment and has a plurality of switches arranged on the air-conditioning operation panel. The operation switch 70 is not of course limited to the air conditioning operation switch, but may be any other switch for operating the devices mounted on the construction or agricultural machine.

Generally, in order to secure operability by the occupant, the operation switch 70 is required to be arranged within the reach of the hand of the occupant. Further, in the construction or agricultural machine with the windshield 4 and the side window glass 5 of the cabin 1 covering the range from above the head to below the knees of the occupant in the seat 3, the operation switch is arranged preferably on the front or side of the occupant in order not to hamper the visual field of the occupant.

Thus, the support member 71 for supporting the operation switch 70 at an appropriate position can be arranged in the neighborhood of the knees of the occupant. According to this embodiment, therefore, an extension leads the warm air to the neighborhood of the knees of the seated occupant through the internal space of the third duct portion 37d, and the support member 71 fixedly supports the operation switch 70 at an appropriate position with the outer wall surface of the third duct portion 37d.

Specifically, at least a part of the third duct portion 37d (extension) is configured of the support member 71 of the operation switch 70. The other component parts of the first foot air duct 35 are similar to those of the fourth embodiment.

The second foot air duct 43 is a pipe for leading the air-conditioning air from the air-conditioning unit 10 to the second foot air outlet 44 and the door foot air outlet 47, and as in the fourth embodiment, has the first duct portion 43a having the second foot air outlet 44.

Further, the second foot air duct 43 according to this embodiment has a second duct portion 43c so configured that the air-conditioning air passes through the interior of the left wall of the cabin 1 and also through the hollow space 60c in the door 60 on the left side of the cabin 1. Specifically, the second duct air portion 43c is configured to communicate with the first duct portion 43a on the left side of the first duct portion 43a in the rear of the seat 3.

The door 60 according to this embodiment includes the side window glass 5, the outer panel 60a of a metal on the outside of the cabin 1, and a door trim 60b of resin on the inside of the cabin 1. A hollow space 60c is formed between the outer panel 60a and the door trim 60b of the door 60. The air-conditioning air flows through the hollow space 60.

Further, the door-side foot air outlet 47 for blowing out the air-conditioning air toward the knees of the occupant is arranged in the neighborhood of the knees of the occupant on the door trim 60b of the door 60. This door-side foot air outlet 47 is arranged horizontally symmetrical with respect to the switch-side foot air outlet 46 about the occupant. Generally, the door trim 47 occupies a wide range below the side window glass 5 of the door 6, and this horizontally symmetric arrangement can be easily realized.

According to this embodiment, therefore, the warm air is passed through the internal space of the second duct portion 43c and warm air is led by an extension to the neighborhood of the knees of the seated occupant. Specifically, at least a part of the second duct portion 43c (extension) is configured of the door 60. The other component parts of the second foot air duct 43 are similar to those of the fourth embodiment.

The operation of this embodiment having the aforementioned configuration is explained. The air-conditioning unit 10 operates in the same manner as in the first embodiment, and in face mode, the interior of the cabin 1 is air-conditioned as in the fourth embodiment. In foot defrost mode, on the other hand, as in the fourth embodiment, the air-conditioning air is blown out from the defroster air outlets 41a, 41b, the side window defroster air outlet 42, the second foot air outlet 44 and the second face air outlet 36c.

Further, the air-conditioning air is blown out toward the knees of the occupant in the direction of arrow U from the switch-side foot air outlet 46, while at the same time heating the interior of the cabin 1 by blowing out the air-conditioning air toward the knees of the occupant in the direction of arrow T from the door-side foot air outlet 47.

In bilevel mode, on the other hand, as in the fourth embodiment, the air blown out to the face from the first face air outlet 36a is set a predetermined amount lower in temperature than the air blown out to the feet from the second foot air outlet 44, the door-side foot air outlet 47 and the switch-side foot air outlet 46, so that the vertical blowout temperature difference is set in a head-cold feet-warm fashion thereby to improve the comfort of the occupant.

According to this embodiment, the air-conditioning air (warm air) can be blown out toward the knees of the occupant from the switch-side foot air outlet 46 and the door-side foot air outlet 47 during the heating operation, and therefore the warm feeling around the knees and thighs of the occupant is improved.

in addition, the switch-side foot air outlet 46 and the door-side foot air outlet 47 can be arranged substantially symmetrically in the horizontal direction as viewed from the occupant and the air-conditioning air can be blown out symmetrically. Thus, there occurs no temperature difference between the left and right knees and the thighs of the occupant.

According to this embodiment, at least a part of the second duct portion 43c (extension) is configured of the door 60. As an alternative, a dedicated duct for establishing communication between the first duct portion 43a and the door-side foot air outlet 47 may be fixedly arranged in the door 60 and may be employed as an extension with equal effect.

Further, according to this embodiment, at least a part of the third duct portion 37d (extension) is configured of the support member 71 of the operation switch 70. Nevertheless, similar effects can be achieved by fixing a dedicated duct for establishing communication between the first duct portion 43a and the switch-side foot air outlet 46 on the support member 71 having no internal hollow space, which duct may be employed as an extension.

### Other Embodiments

This invention is not limited to the aforementioned embodiments and can be variously modified as described below.

(1) In the first to third embodiments described above, the third duct portion 90b integrated with the rail 90 and the third duct portion 37c extended in such a manner as to be coupled to the rail 9 are formed with the foot air outlets 40, 40a, the defroster air outlets 41a, 41b, 41c, 41d and the side window defroster air outlets 42, 42a. Nevertheless, the positions and the number of the air outlets are not limited by this.

In order to attain the defrosting effect and reduce the loss of heat over the wide range of the windshield 4 or the side window glass 5, for example, the positions and the number of the defroster air outlets 41a, 41b, 41c, 41d and the side window defroster air outlets 42, 42a may be changed. This is also the case with the positions and the number of the face air outlets 36a, 36b arranged on the face air duct 35.

(2) In the fourth and fifth embodiments described above, the extensions (second duct portion 43b, third duct portion 37d and second duct portion 43c) are formed with the first foot air outlet 45, the switch-side foot air outlet 46 and the door-side foot air outlet 47, respectively, for blowing out the air-conditioning air toward the knees of the occupant. As an alternative, these extensions may be formed with an air outlet for blowing out the air-conditioning air toward the windshield 4 and an air outlet for blowing out the air toward the side window glass 5.

By doing so, the frosting of the windshield 4 and the side window glass 5 can be prevented, and the loss of heat to the windshield 4 and the side window glass 5 can be reduced for an improved warm feeling of the occupant.

(3) In the fifth embodiment described above, a plurality of extensions (third duct portion 37, second duct portion 43c) are formed with the foot air outlets 46, 47, respectively, for blowing out the air-conditioning air toward the knees of the occupant. Further, the extensions 37c, 90b according to the first to fourth embodiments may be added to blow out the air-conditioning air toward the knees of the occupant. As a result, the warm feeling of the occupant can be improved. Also, each extension according to the fifth embodiment can be used independently.

(4) In each embodiment described above, the atmospheric (external) air door 18, the internal air door 17, the face air door 32 and the foot air door 34 are rotationally driven by an electric actuator. As an alternative, a door operation member manually operated on an air conditioning operation panel may be coupled to the rotary shaft of each door through a mechanical transmission mechanism such a cable or a link mechanism to rotationally operate each door by manual operation of the door operation member.

(5) In each embodiment described above, the windshield 4 is divided into the upper windshield 4a and the lower windshield 4b, and as described above, the rail 9, 90 constituting the frame member according to the invention functions as a fixing member for fixing the nearby ends of the respective glass to each other.

In the case where the windshield 4 is formed of a single glass pane, in contrast, a duct extension having foot air outlets may be arranged as a frame member extending horizontally of the cabin 1 along the windshield 4 in such a manner as to bridge the window frames thereby to function as a skeleton member for reinforcing the windshield. Further, the frame member functioning as the skeleton member may be arranged substantially at the same height as the knees of the occupant.

(6) In each embodiment described above, the invention is applied to the cabin of the hydraulic shovel. As an alternative, this invention is applicable to the cabins of various construction and agricultural machines having the windshield and the side window glass covering a wide range from above the head to below the knees of the seated occupant. Also, the construction and agricultural machines according to this invention are not limited to self-propelled ones but applicable also to stationary ones as well.

While the invention has been described by reference to specific embodiments chosen for purposes of illustration, it should be apparent that numerous modifications could be made thereto, by those skilled in the art, without departing from the basic concept and scope of the invention.

What is claimed is:

1. An air conditioning system mounted on a construction or agricultural machine with the windshield and the side window glass of the cabin covering the range from above the head to below the knees of a seated occupant in the cabin, comprising:
a blower for blowing the air into the cabin;
a heat exchanger for heating the air blown by the blower;
a duct arranged downstream of the heating heat exchanger in the air flow to supply the warm air after passage through the heating heat exchanger; and
an air outlet for blowing the warm air into the cabin;
wherein the duct has an extension for leading the warm air to the neighborhood of the knees of the seated occupant, and
wherein the air outlet is arranged on the extension.

2. The air conditioning system mounted on a construction or agricultural machine according to claim 1,
further comprising a frame member extended horizontally along the windshield of the cabin substantially at the same height as the knees of the seated occupant,
wherein the extension is fixed on the frame member.

3. The air conditioning system mounted on a construction or agricultural machine according to claim 1,
further comprising a frame member extended horizontally along the windshield of the cabin substantially at the same height of the knees of the seated occupant,
wherein at least a part of the extension is configured of the frame member.

4. The air conditioning system mounted on a construction or agricultural machine according to claim 2,
wherein a plurality of the air outlets are arranged at predetermined intervals horizontally on the extension.

5. The air conditioning system mounted on a construction or agricultural machine according to claim 1, further comprising a console box arranged on the side of the seat,
wherein the extension is fixed on the console box.

6. The air conditioning system mounted on a construction or agricultural machine according to claim 1, further comprising a console box arranged on the side of the seat,
wherein at least a part of the extension is configured of the console box.

7. The air conditioning system mounted on a construction or agricultural machine according to claim 5,
wherein the extension is arranged in the console box.

8. The air conditioning system mounted on a construction or agricultural machine according to claim 5,
wherein a plurality of the air outlets are arranged at predetermined intervals in the vertical direction of the extension.

9. The air conditioning system mounted on a construction or agricultural machine according to claim 1,
further comprising a door used by the occupant to get in and out
wherein the extension is fixed on the door.

10. The air conditioning system mounted on a construction or agricultural machine according to claim
further comprising a door for the occupant to get in and out
wherein at least a part of the extension is configured of the door.

11. The air conditioning system mounted on a construction or agricultural machine according to claim 9,
wherein the extension is arranged in the door.

12. The air conditioning system mounted on a construction or agricultural machine according to claim 1,
further comprising a support member for supporting the operation switch
wherein the extension is fixed on the support member.

13. The air conditioning system mounted on a construction or agricultural machine according to claim 1,
further comprising a support member for supporting the operation switch
wherein at least a part of the extension is configured of the support member.

14. The air conditioning system for a construction or agricultural machine according to claim 1,
wherein the air outlet is arranged at the position where the warm air is blown out toward the knees of the seated occupant.

15. The air conditioning system for a construction or agricultural machine according to claim 1,
wherein the air outlet is arranged at the position where the warm air is blown out toward the windshield.

16. The air conditioning system for a construction or agricultural machine according to claim 1,
wherein the air outlet is arranged at position where the warm air is blown out toward the side window glass.
